(19) United States
(12) Patent Application Publication
(10) Pub. No.: US 2024/0255325 A1
(43) Pub. Date: Aug. 1, 2024

(54) CONSTELLATION SIMULATOR, SYSTEM AND METHOD FOR CALIBRATING A STAR SENSOR

(71) Applicant: Jena-Optronik GmbH, Jena (DE)

(72) Inventors: Uwe SCHMIDT, Bürgel (DE); Erik MÖLLER, Tautenburg (DE); Bernd HÄDRICH, Jena (DE); Steffen HAHN, Stadtroda (DE); Michael BOY, Laucha (DE); Sebastian COLDITZ, Jena (DE)

(73) Assignee: Jena-Optronik GmbH, Jena (DE)

(21) Appl. No.: 18/422,635

(22) Filed: Jan. 25, 2024

(30) Foreign Application Priority Data
Jan. 27, 2023 (DE) 10 2023 102 002.1

(51) Int. Cl. G01D 18/00; B64G 99/00; G01M 11/02

(52) U.S. Cl. CPC G01D 18/00; B64G 99/00; G01M 11/0242

(57) ABSTRACT

The present disclosure relates to a calibrated constellation simulator, a system and a method for calibrating and/or testing a star sensor assembled on a spacecraft. The calibrated constellation simulator comprises an optical device configured to project a defined star formation (IRF) of a star catalog onto a star sensor assembled on a spacecraft. Further, the calibrated constellation simulator comprises an alignment unit with a position and/or location reference (ARF) of the calibrated constellation simulator configured to detect a position and/or location of the calibrated constellation simulator in space, wherein the defined star formation (IRF) and the position and/or location reference (ARF) are in a first fixed calibrated rotation (Q_{OSPS}) with respect to one another. The calibrated constellation simulator improves the calibration of the star sensor as an independent calibration standard. The constellation simulator becomes a calibration standard.

### CROSS-REFERENCE TO RELATED APPLICATION

This application claims priority to German Patent Application No. 10 2023 102 002.1, filed on Jan. 27, 2023, the entire contents of which are hereby incorporated by reference.

### BACKGROUND

The disclosure relates to a calibrated constellation simulator for calibrating and/or testing a star sensor assembled on a spacecraft. The disclosure also relates to a system for calibrating and/or testing a star sensor assembled on a spacecraft. The disclosure further relates to a method for calibrating and/or testing a star sensor assembled on a spacecraft, a computing unit and a computer program.

Star sensors are well known and embody a highly accurate 3-axis inertial angle system. The angle measurement can be output in the boresight reference system (BRF) of the star sensor. Star sensors can be used for the orientation of spacecraft. For this purpose, the star sensor takes images of certain areas of the environment and, for example, a computing unit processes these images to determine the position of the stars in relation to the spacecraft. The spacecraft can compare the known position of the stars in relation to the actual observed position to determine the orientation of the spacecraft in the room, which can also accurately determine its position in space. In order to be able to use a star sensor in a spacecraft, it must be calibrated to the spacecraft. To transmit the star sensor BRF by means of a rotation matrix to the spacecraft reference system (SCRF), an optically measurable reference system is required, which is calibrated by the manufacturer of the star sensor via a rotation matrix to the BRF of the star sensor. The aforementioned reference system is referred to as the alignment reference system (ARF) and can be designed as a mirror cube permanently assembled on the star sensor. An integrator/user can measure the mirror cube assembled on the star sensor and thus produce the rotation to the spacecraft reference system (SCRF), whereby the star sensor BRF system is known via the ARF/BRF rotation in the SCRF (reference system in the spacecraft).

This method has the disadvantage that a permanently assembled mirror cube is required for the purpose of transmitting the star sensor BRF to the outside. The permanently assembled mirror cube causes high procurement and assembly costs and increases the sensor mass itself, which can have an impact on the spacecraft. Further, there is an increased effort for implementing the calibration of the star sensor, which causes additional costs for the calibration. Furthermore, the mirror cube remains on the star sensor, wherein this has no significance in operational use itself, but can have a detrimental effect on the spacecraft due to the additional weight. In addition, the known method has the disadvantage that the ARF/BRF measurement must be performed by the star sensor manufacturer itself, as the operator of the spacecraft or the user of the star sensor does not have any measurement technology available. Calibration is also time-consuming and ties up additional measurement technology resources. Further, due to the time required for the measurement, implementing the method at the manufacturer of the star sensor is not compatible with the required production throughput, particularly when manufacturing several star sensors per week, as is necessary for constellation programs.

### SUMMARY

The object of embodiments of the disclosure is therefore to at least partially overcome the aforementioned disadvantages known in the prior art and to structurally and/or functionally improve the aforementioned constellation simulator in such a manner that a user/integrator can calibrate (calibrate and/or test) the star sensor. In addition, the object of embodiments of the disclosure is to structurally and/or functionally improve a system and a method mentioned at the beginning.

The object is solved with a calibrated constellation simulator with the features of claim 1. Furthermore, the object is solved with a system having the features of claim 5. The object is further solved by a method having the features of claim 12, as well as a computing unit having the features of claim 14 and a computer program having the features of claim 15. Advantageous embodiments and/or further embodiments are the subject matter of the subclaims, the description and/or the accompanying figures. Particularly, the independent claims of one category of claims may also be further defined and/or combined analogously to the dependent claims of another category of claims. The device and method features described below can also be combined with one another and/or further developed.

Summarized and represented in other words, the disclosure thus provides, among other things, a constellation simulator. The constellation simulator is designed to calibrate and/or test a star sensor assembled on a spacecraft. The constellation simulator comprises an optical device. The optical device is configured to project a defined star formation of a star catalog. In particular, the optical device is configured to project the defined star formation onto a star sensor assembled on a spacecraft. An alignment unit is also provided. The alignment unit has a position and/or location reference of the constellation simulator. The alignment unit is further configured to detect a position and/or layer of the calibrated constellation simulator in the room. The defined star formation and the position and/or location reference are in a first fixed calibrated rotation relative to one another.

For the purposes of the present disclosure, a constellation simulator may be designed as a tool to represent and examine stars and/or other celestial objects in a particular environment and at a particular time. It can be used to determine the positions of stars and planets, simulate and/or recreate the visibility of certain objects. Further, a calibration is a process to obtain an accurate measurement in order to determine or calibrate something. In general, various measuring apparatus or instruments are used during calibration to determine the position or other properties of the star sensor. Testing can be understood as checking the calibration and/or testing a star sensor. Further, for the purposes of the present disclosure, an optical device may be understood to be an apparatus or instrument that can be used to provide, collect, concentrate, project or modify light. It can consist of a variety of optical elements such as a light source, lenses, mirrors or prisms that interact together to influence the light and send it onto surfaces to be projected, thus projecting them. For the purposes of the disclosure, star formations are to be understood as a pattern or constellation of stars that have a determined shape or form when viewed from the perspective of the Earth and/or a spacecraft. These patterns can be described in a star catalog. In this star catalog, the star formations can be classified in different manners. A star catalog can comprise the positions and/or brightness of the stars and/or other astral bodies, as well as information about the stars themselves or combinations/formations of stars (possibly also planets and/or other celestial bodies) and/or their movements. Further, for the purposes of the present disclosure, an alignment unit is to be understood as a known reference which has a position and/or location reference (ARF). The position and/or location reference (ARF) is thus a method or system used to determine the position and/or layer of an object or unit with respect to a known reference. In particular, a highly accurate 3-axis rotation matrix for the star sensor alignment reference (BRF) can be created using the position and/or location reference (ARF). Further, for the purposes of the present disclosure, a first fixed calibrated rotation (Q_{OSPS}) is to be understood as the transformation inherent in the constellation simulator between the star formation and the alignment unit.

Embodiments of the disclosure make it possible to dispense with the mirror cube on the star sensor itself when calibrating and/or testing the star sensor and thus to dispense with the time-consuming alignment measurement during the production of the star sensor. The star sensor can be calibrated and/or tested by the manufacturer/designer of the spacecraft. Embodiments of the disclosure thus reduce the production effort and achieves a high production throughput, as is necessary for constellation programs. Further, the costs for testing and calibration can be reduced. Further, no mirror cube needs to remain installed on the star sensor or the spacecraft, which reduces the mass of both the star sensor and the spacecraft.

In one embodiment of the calibrated constellation simulator, it is provided that the optical device has at least one optical system together with a, particularly coherent, light source and a static constellation mask with the defined star formation of the star catalog. By means of the optical device, a star formation of the star catalog can be projected. The optics can be made up of one lens or a plurality of differently or identically designed lenses. The lenses can collect, focus or project light. They can be used to collect the light from the coherent light source and focus it on a determined point to project it onto the star sensor, for example. Lenses can also be used to correct the light provided, e.g. to correct distortions or chromatic aberrations. They can also be used to modify the light provided, e.g. to polarize it or change the color. The coherent light source is a light source that emits monochromatic and/or phase-coherent light. Alternatively, it may be provided that the device has a static or dynamic display unit for representation of the star formation of the star catalog. A static display unit may comprise a display that does not perform any changes to the displayed content once it is set up. No movement or interaction can be represented, only static content. A dynamic display unit can be designed as a display that changes or is animated to show different content. For example, the dynamic display unit can be designed as an LED screen that is used to display static content, animations or other moving content.

In a further embodiment of the calibrated constellation simulator, it is provided that the fixed calibrated rotation is implemented in a quaternion metric. The quaternion metric is a method of measuring the similarity or distance between two quaternions, which is used to represent the orientation of objects or the change of orientation in the space. A quaternion is a special form of a complex number that is used to represent rotations in three-dimensional space. This can be used to determine the orientation of objects. In an alternative embodiment, it can be provided that the fixed calibrated rotation is implemented in a rotation matrix. A rotation matrix is a matrix that can be used to represent a rotation around a determined axis or around a determined point in three-dimensional space.

In a further embodiment of the calibrated constellation simulator, the alignment unit may have one or more mirror cubes or be designed as a mirror cube. Each of the sides of the mirror cube can have a unique assignable calibration rotation in the form of a rotation matrix or a quaternion. The sides are designed as mirrors. The mirror cube(s) can be used to measure the layer in space.

In a further embodiment of the calibrated constellation simulator, the alignment unit may have one or more prisms or be designed as a prism. Each of the sides of the prism(s) can have a unique assignable calibration rotation in the form of a rotation matrix or quaternion. The prism(s) can be used to measure the layer in space.

In another embodiment of the calibrated constellation simulator, the alignment unit may have one or more polished surfaces. Each of the polished surfaces can have a unique assignable calibration rotation in the form of a rotation matrix or quaternion. The polished surfaces are designed to be reflective/mirror-like. The polished surface/s can be used to measure the layer in the space.

In a further embodiment of the calibrated constellation simulator, the alignment unit may be designed as one or more reflective surfaces. In one embodiment, the reflective surfaces can be designed as reflective adhesive pads. Each reflective surface or adhesive pad can have a unique assignable calibration rotation in the form of a rotation matrix or quaternion. By means of the adhesive pads, a reference can be designed with little time and material effort. The reflective surface/s or adhesive pad/s can be used to measure the layer in the space.

A second aspect of the disclosure relates to the system for calibrating and/or testing a star sensor assembled on a spacecraft. The system includes a star sensor. In embodiments, the star sensor is assembled/can be assembled on a spacecraft. The star sensor has sensor optics. The sensor optics have an alignment reference and the star sensor has a mechanical position and/or location reference with reference to the spacecraft. The alignment reference and the mechanical position and/or location reference are in a second rotation relative to one another. The system further includes a calibrated constellation simulator according to the disclosure. The calibrated constellation simulator is arranged/can be arranged in the space around the spacecraft. The calibrated constellation simulator can be and/or be arranged on the star sensor. For example, the calibrated constellation simulator can be placed on or attached to the star sensor. The system also includes a detection unit. The detection unit is assembled/can be assembled on the spacecraft. The detection unit is configured to detect at least one feature of the alignment unit of the calibrated constellation simulator. The system is configured to calibrate the star sensor. According to the disclosure, the calibration of the star sensor comprises a determination of at least one feature of the alignment unit by the detection unit after a transfer of the alignment reference to the position and/or location reference using the second rotation and the fixed calibrated rotation.

For the purposes of the present disclosure, sensor optics means optics used to focus or direct light onto the star sensor. The sensor optics may comprise one or more lenses or mirrors that collect, focus or project the light to direct it onto the star sensor. The sensor optics can also be used to correct or modify the light to improve the performance and accuracy of the star sensor. The sensor optics has an alignment reference (BRF). The alignment reference (BRF) can be understood as the output of the angle measurement in the boresight reference system of the star sensor. It can be used to determine the relative orientation of the star sensor within the spacecraft or, for example, a platform. For the purposes of the present disclosure, the second rotation (Q_{STR}) is the quaternion output by the star sensor. It describes the 3-axis rotation between the star formation and the alignment reference of the star sensor. Further, for the purposes of the present disclosure, a mechanical position and/or location reference (MRF) is to be understood as the position that describes the mounting position of the star sensor with respect to the spacecraft.

In one embodiment of the system, the detection of the least one feature by the detection unit comprises optical detection using an optical detection unit. The optical detection unit can be designed as a laser. The detection unit is assembled/can be assembled on the spacecraft. The position of the detection unit is known and may comprise the spacecraft reference frame (SCRF). Additionally or alternatively, the detection unit and/or the spacecraft may comprise the spacecraft reference system (SCRF). The laser can be designed to optically detect a feature of the alignment unit, particularly a projected star formation or part of a projected star formation.

In a further embodiment of the system, optical detection is carried out using autocollimation. Autocollimation comprises the measurement of the position and/or orientation of optical elements. It is based on the use of light that is reflected by an optical element, particularly the alignment unit, and falls back onto another element. If the position and orientation of the two optical elements are correct, the reflected light traces should match and coincide.

In a further embodiment of the system, the fixed calibrated rotations are or are carried out in a quaternion metric or in a rotation matrix.

In a further embodiment of the system, the transfer is determined by the following formula:

$${Q}_{A R F} ( BRF , IRF ) = Inv ( {Q}_{S T R} \times {Q}_{OSPS} )$$

wherein “Q_{ARF}” represents the transfer, “Inv” the operator for the inversion of a quaternion, “Q_{STR}” the quaternion output by the star sensor, ‘×’ the operator for the quaternion multiplication, and “Q_{OSPS}” the calibrated rotation. Through this transfer and the application of the quaternion transformation, the star sensor BRF can be measured optically from the outside via the alignment unit of the constellation simulator.

In a further embodiment of the system, the star sensor is calibrated to a reference system of the spacecraft. Using the reference system of the spacecraft, the required 3-axis rotation can be determined.

In another embodiment of the system, the spacecraft is designed as a satellite or as a space capsule or as a spacecraft. The system may comprise the spacecraft. The spacecraft can be used for earth observation, for example for high-resolution earth observation. The spacecraft can be a drone, an aircraft, a satellite, particularly an artificial satellite, for example an earth satellite, a space probe, for example an orbiter, a rocket, a space shuttle, a spaceship, a spacecraft, a space capsule, a space station or similar. The spacecraft can be designed to move in space or be transported to space. The spacecraft can be a space missile. The spacecraft can be designed to be placed in an orbit around the earth and/or to move and/or hover in an orbit around the earth. The spacecraft may be designed to travel and/or hover at an altitude of, for example, approximately 100 m, 10 km and/or 1000 km or more. The spacecraft can be designed to be placed in orbit around a planet and/or celestial body and/or to move and/or hover in a circular path of the planet or celestial body. The celestial body can, for example, be a planet, star, moon, asteroid, etc. The spacecraft may have a propulsion system, such as an engine, rocket propulsion and/or braking and/or steering nozzles, or similar.

In accordance with a third aspect, the disclosure relates to a method for calibrating and/or testing a star sensor assembled on a spacecraft using a calibrated constellation simulator. The method according to the disclosure comprises the following method steps. In a first method step, a second rotation is detected. The second rotation results from a mutual alignment reference and a mechanical position and/or location reference. The alignment reference is a reference of a sensor optics of the star sensor and the mechanical position and/or location reference is a reference of the star sensor with respect to the spacecraft. In a second method step, the alignment reference is transferred to a position and/or location reference of a calibrated constellation simulator using the second rotation and a first fixed calibrated rotation. In a third method step, the star sensor is calibrated by determining at least one feature of an alignment unit of the calibrated constellation simulator by means of a detection unit assembled on the spacecraft.

In accordance with one embodiment of the method according to the disclosure, a further step comprises reading out a fixed calibrated rotation resulting from a defined star formation of a star catalog and a position and/or location reference of an alignment unit of a calibrated constellation simulator. The fixed calibrated rotation comprises the transformation inherent in the star sensor and can be read out from a storage, particularly a storage of the constellation simulator, the computing unit and/or the spacecraft.

In accordance with a fourth aspect, the disclosure relates to a computing unit. The computing unit has a processor unit, a communication interface and a storage unit. The computing unit is designed for use in a calibrated constellation simulator. The computing unit is further designed to calibrate and/or test a star sensor assembled on a spacecraft. The computing unit can have a processor unit, a storage unit and a communication interface. The computing unit may further have additional components. The processor unit is in data communication with the storage unit and the communication interface, in embodiments via a communication medium. The communication medium can be designed in such a manner that various communication protocols can be used for data communication. For the purposes of the present disclosure, a computing unit is to be understood as a system which receives corresponding data as input and provides output signals in accordance with a predetermined program. The output signals can be provided to the constellation simulator such that the transformation is determined. The control device may comprise a processor unit configured to perform an embodiment of the method according to the disclosure. For this purpose, the processor unit may have at least one microprocessor and/or at least one microcontroller and/or at least one FPGA (field programmable gate array) and/or at least one DSP (digital signal processor). Furthermore, the processor unit may have program code that is configured to perform the embodiment of the method according to the disclosure when implemented by the processor unit. The program code can be stored in a storage unit of the processor unit and/or computing unit. The processor circuit of the processor unit may, for example, have at least one circuit board and/or at least one SoC (system on chip).

In accordance with a fifth aspect, the disclosure relates to a computer program. The above-described embodiments of the method in accordance with the third aspect of the disclosure may also be designed as a computer program, wherein a computing unit (e.g., a computer, microcontroller, FPGA, PLC, etc.) is caused to perform the above-described method in accordance with the disclosure when the computer program is performed on a computing unit or on a processor of the computing unit. The computer program may be provided, for example as a signal, by download or stored in a storage unit of the computing unit with computer-readable program code contained therein to cause the computing unit to execute instructions in accordance with the above method. The computer program can also be stored on a machine-readable storage medium. An alternative approach provides for a storage medium which is determined for storing the method described above (as program code) and is readable by a computer or a processor of the computer.

The above embodiments and further configurations can be combined with one another as desired, if appropriate. Other possible embodiments, further configurations and implementations of the disclosure also comprise combinations of features of the disclosure not explicitly mentioned above or described below with respect to the exemplary embodiments. Individual aspects can also be added as improvements or additions to the respective basic form of the present disclosure. In particular, features of the method claims can be converted and/or executed by corresponding components of the constellation simulator or the system, according to which they supplement or extend their functionality. Aspects of the method claims can therefore also be used for the constellation simulator or the system.

### BRIEF DESCRIPTION OF THE DRAWINGS

Exemplary embodiments of the disclosure are described in more detail below with reference to figures, in which the following are shown schematically and by way of example:

FIG. 1 shows a schematic diagram of a calibrated constellation simulator in accordance with one embodiment of the disclosure;

FIG. 2 shows a schematic diagram of a system in accordance with one embodiment of the disclosure;

FIG. 3 shows a flow chart of a method in accordance with one embodiment of the disclosure, and

FIG. 4 shows a schematic diagram of a computing unit in accordance with one embodiment of the disclosure.

The accompanying figures are intended to provide a further understanding of the embodiments of the disclosure. They illustrate embodiments and serve to explain the principles and concepts of the disclosure in connection with the description. Other embodiments and many of the advantages mentioned are shown in the figures. The elements of the figures are not necessarily shown to scale. In the figures, identical, functionally identical and identically acting elements, features and components are each provided with the same reference numerals, unless otherwise stated.

### DETAILED DESCRIPTION

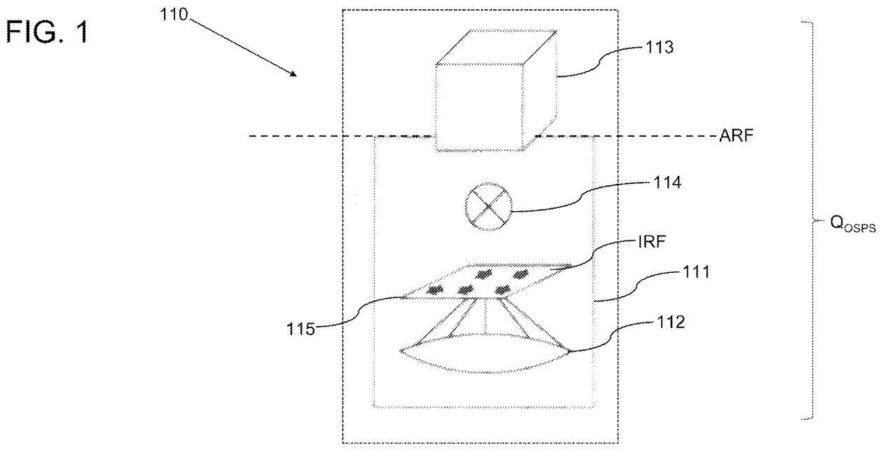

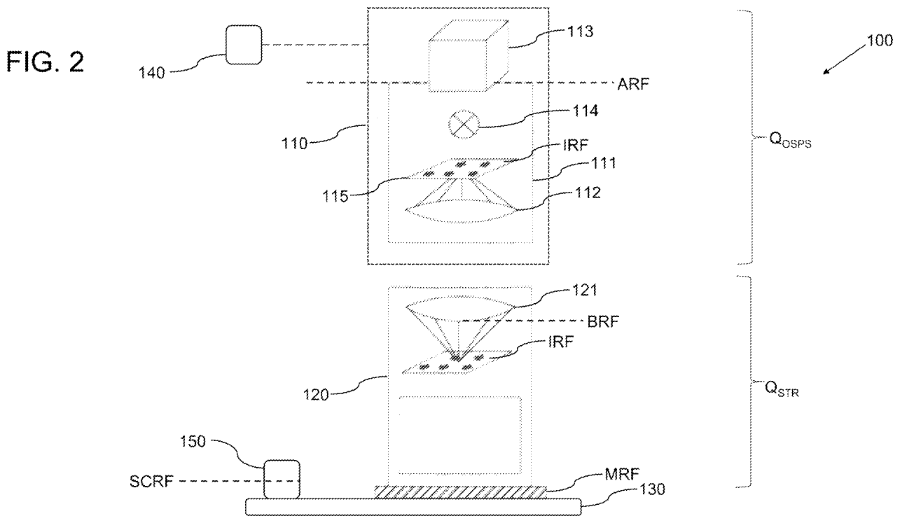

FIG. 1 shows a schematic diagram of a calibrated constellation simulator in accordance with one embodiment of the disclosure; In FIG. 1, reference numerals 110 denotes the calibrated constellation simulator according to the disclosure. The constellation simulator 110 is designed to calibrate and/or test a star sensor assembled on a spacecraft 130, for example a satellite, a space capsule or a spacecraft. The calibrated constellation simulator 110 comprises an optical device 111 and an alignment unit 113. The optical device 111 is configured to project a defined star formation IRF of a star catalog, in embodiments, onto a star sensor 120 assembled on a spacecraft 130 (see FIG. 2). Further, the constellation sensor 110 comprises the alignment unit 113 with a position and/or location reference ARF of the calibrated constellation simulator 110 configured for detecting a position and/or layer of the calibrated constellation simulator 110 in space, wherein the defined star formation IRF and the position and/or location reference ARF are in a first fixed calibrated rotation Q_{OSPS} with respect to one another.

With the constellation simulator 110 according to the disclosure, a mirror cube assembled on the star sensor can be dispensed with, and thus also the time-consuming alignment measurement as part of the manufacture of a star sensor. Embodiments of the present disclosure enable a higher production throughput to be achieved, as is necessary for a constellation program. Further, time, cost and mass savings can be achieved for the star sensor. Embodiments of the present disclosure provide the constellation simulator 110 according to the disclosure with an alignment reference. The constellation sensor 110 thus comprises an optical reference comprising an alignment unit 113. The alignment unit 113 may have or be designed to have one unit from the following group of units: one or more mirror cubes, one or more prisms, one or more polished surfaces, and/or one or more reflective elements, e.g. adhesive pads. The optical reference is designed to measure its layer in space.

The transformation Q_{OSPS} (IRF->ARF) inherent in the constellation simulator 110 as a fixed rotation between the star formation IRF (inertial reference frame) comprising a real star pattern from a star catalog and the position and/or location reference ARF of the alignment unit 113 (alignment reference frame) is used to reference the alignment unit 113 on the constellation simulator to the BRF of the star sensor Q_{STR} (IRF->BRF) via its common quaternion Q_{STR}. Thus, the star sensor 120 BRF can be connected to the constellation simulator 110 ARF via the measured quaternion Q_{STR} and the calibrated rotation Q_{OSPS} as follows:

$${Q}_{A R F} ( BRF , IRF ) = Inv ( {Q}_{S T R} \times {Q}_{OSPS} )$$

The calibrated rotation Q_{OSPS} can be executed in a quaternion metric Q_{OSPS} or in a rotation matrix A_{OSPS}. Thus, the constellation simulator 110 according to the disclosure becomes a calibration standard for calibrating and/or testing star sensors 120 on a spacecraft 130 (see FIG. 2) by means of an integrator to the reference system of the spacecraft SCRF (see FIG. 2). It may be provided that the constellation simulator 110 is calibrated once by the manufacturer. Here, each side of the alignment unit 113 receives a clearly assignable calibration rotation, for example in the form of a rotation matrix or a quaternion. By means of the optical device 111, a known star formation from a star catalog can be projected onto the star sensor 120 (see FIG. 2) by an optical system of the optical device 111. The calibrated constellation simulator 110 may be used to calibrate and/or test a star sensor 120 already assembled on a spacecraft 130.

FIG. 2 shows a schematic diagram of a system in accordance with one embodiment of the disclosure; In FIG. 2, reference numerals 100 denotes the system according to the disclosure with a spacecraft 130. A star sensor 120 is assembled on the spacecraft 130. Further, the spacecraft 130 has a detection unit 150. In addition, the system 100 has the calibrated constellation simulator 110 according to the disclosure.

The star sensor 120 is in embodiments assembled on the spacecraft 130 and has sensor optics 121. The sensor optics 121 has an alignment reference BRF. The star sensor 120 has a mechanical position and/or location reference MRF with respect to the spacecraft 130. The alignment reference BRF and the mechanical position and/or location reference MRF are in a second rotation Q_{STR} to one another.

The calibrated constellation simulator 110 may be arranged in space around the spacecraft 130. In particular, the calibrated constellation simulator 110 may be arranged and/or mounted on the star sensor 120. The detection unit 150 is assembled on the spacecraft 130 and configured to detect at least one feature of the alignment unit 113 of the calibrated constellation simulator 110. The system 100 is configured for calibration, which comprises a determination of at least one feature of the alignment unit 113 by the detection unit 150 after a transfer of the alignment reference BRF to the position and/or location reference ARF using the second rotation Q_{STR} and the fixed calibrated rotation Q_{OSPS}.

The system 100 further has the computing unit 140 according to the disclosure. The computing unit 140 can be arranged centrally or decentrally and can be in data communication with the system 100 and/or the constellation simulator 110 and/or the star sensor 120 via a communication medium, for example signal lines and/or BUS system and/or Ethernet and/or WLAN. Alternatively, the computing unit 140 can be outsourced to a cloud.

Using the system 100 according to the disclosure and the calibrated constellation simulator 110 according to the disclosure, an integrator/user can calibrate and/or test the star sensor 120 himself after mounting it on a spacecraft 130. No complex measurement technology is required for calibration and/or testing. By means of a calibrated star formation IRF of a star catalog of the star sensor, the system 100 uses the rotation Inv(Q_{STR}) supplied by the star sensor from the BRF into the IRF and the fixed calibrated constellation simulator 110 rotation Q_{OSPS} from the IRF into the ARF to make the star sensor 120 BRF visible (measurable) to the outside. The quaternion representation (quaternion metric with Q_{OSPS}) or rotation matrices (classic rotation matrix A_{OSPS}) can be used for the calculation. The system 100 uses the calibrated constellation simulator 110, whose 3-axis rotation is known between the output star formation IRF of the constellation simulator 110 and the position and/or location reference ARF of the fixed assembled alignment unit 113. The quaternion Q_{STR} provided by the star sensor 120 describes the 3-axis rotation between the IRF and the BRF of the star sensor 120. The known 3-axis rotations STR and OSPS transfer the star sensor BRF to the ARF of the calibrated constellation simulator 110 through the following relationship:

$${Q}_{A R F} ( BRF , IRF ) = Inv ( {Q}_{S T R} \times {Q}_{OSPS} ) .$$

The star sensor 120 BRF can be measured optically from the outside, e.g. by means of autocollimation, via the alignment unit 113 of the calibrated constellation simulator 110 through the transfer and application of the quaternion transformation. The required 3-axis rotation to the reference system of the SCRF spacecraft can be determined. For example, this can be determined by an integrator/user.

The constellation simulator 110 ARF has a fixed calibrated relationship to the IRF via the Q_{OSPS}, which means that the calibrated constellation simulator 110 can be placed in any orientation relative to the star sensor 120. There must be no optical field clipping between the calibrated constellation simulator 110 and the star sensor 120. The calibrated constellation simulator 110 can be set up with any roll orientation (z axis). For alignment in the x-y axis without optical field trimming, a corresponding mounting device can be used. By means of the present disclosure, the constellation simulator 110 can be used as an alignment calibration standard for calibrating and/or testing star sensors 120 assembled on spacecraft 130.

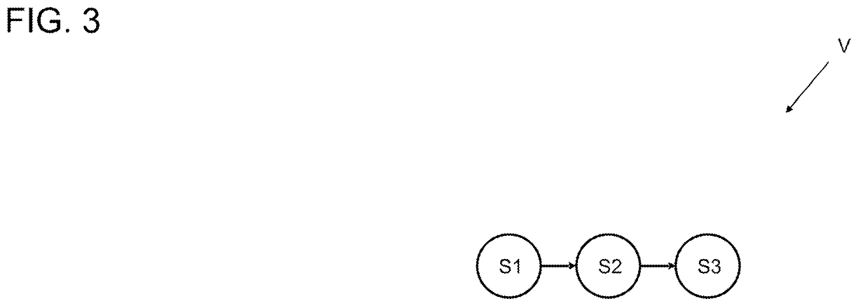

FIG. 3 shows a flow chart of a method in accordance with one embodiment of the disclosure. In the embodiment shown, the method V comprises several method steps. In a first method step S1, a second rotation Q_{STR} is detected, which results from a relative alignment reference BRF and a mechanical position and/or location reference MRF. The alignment reference BRF is a reference of a sensor optics 121 of the star sensor 120, and the mechanical position and/or location reference MRF is a reference of the star sensor 120 with respect to the spacecraft 130.

In a further method step S2, the alignment reference BRF is transferred to a position and/or location reference ARF of a calibrated constellation simulator 110 using the second rotation Q_{STR} and a first fixed calibrated rotation Q_{OSPS}.

In a further method step S3, a calibration S3 of the star sensor 120 is performed by determining at least one feature of an alignment unit 113 of the calibrated constellation simulator 110 by a detection unit 150 assembled on the spacecraft 130.

Furthermore, a readout of a fixed calibrated rotation Q_{OSPS} can be provided, which results from a defined star formation IRF of a star catalog and a position and/or location reference ARF of an alignment unit 113 of a calibrated constellation simulator 110.

The order of the method steps, particularly as described in the illustrated embodiment, and/or partial aspects of the method steps, where appropriate, can also be changed and/or exchanged.

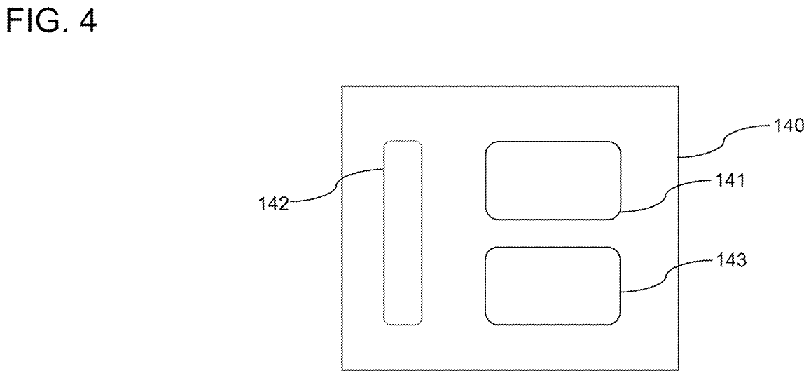

FIG. 4 shows a schematic diagram of a computing unit in accordance with one embodiment of the disclosure. In FIG. 4, reference numerals 140 denote the computing unit according to the disclosure for use in a calibrated constellation simulator 110. The computing unit 140 can be used to calibrate and/or test a star sensor 120 assembled on a spacecraft 130 (see FIG. 2). The computing unit 140 can be implemented as a computer, control apparatus or as a control unit in the system 100 (see FIG. 2). Alternatively, the computing unit 140 can be implemented in a cloud. The data is exchanged via data communication between the computing unit 140 in the cloud and the system 100 via a communication connection/data communication connection.

The computing unit 140 has a storage unit 141. In the storage unit 141, the method for calibrating and/or testing a star sensor 120 assembled on a spacecraft 130 using a calibrated constellation simulator 110 (see FIG. 2) can be stored as program code. The computing unit 140 further has a processor unit 143. The processor unit 143 is designed to carry out the method according to the disclosure and the method steps. The processor unit 143 is in data communication with the storage unit 141 via a communication interface 142. The communication interface 142 may comprise appropriate communication protocols and hardware implementation for communication. Further, the communication interface 142 is designed to provide data communication with the computing unit 140 and the system 100 (see FIG. 2) and the components of the system 100. In addition, the communication interface 142 may be designed for communication of the system 100 with the cloud.

The term “may” refers in particular to optional features of the disclosure. Accordingly, there are also developments and/or exemplary embodiments of the disclosure which additionally or alternatively have the respective feature or the respective features. From the feature combinations disclosed in herein, isolated features may also be singled out as required and, by resolving an optionally existing structural and/or functional relationship between the features in combination with other features, be used to delimit the subject matter of the claim. The order and/or number of method steps may be varied.

### REFERENCE SIGNS

100 system
110 calibrated constellation simulator
111 optical device of the calibrated constellation simulator
112 optics of the optical device
113 alignment unit
114 coherent light source
115 static constellation mask/static or dynamic display unit
120 star sensor
121 sensor optics
130 spacecraft
140 computing unit
141 storage unit
142 communication interface
143 processor unit
150 detection unit
ARF position and/or location reference of the calibrated constellation simulator
A_{OSPS} rotation matrix
BRF alignment reference
IRF defined star formation
MRF mechanical position and/or location reference of the star sensor
Q_{OSPS} first fixed calibrated rotation
Q_{STR} second rotation
SCRF reference system of the spacecraft
V method
S1-S3 method steps

1. A calibrated constellation simulator for calibrating and/or testing a star sensor assembled on a spacecraft, comprising:
an optical device configured to project a defined star formation (IRF) of a star catalog onto the star sensor assembled on the spacecraft, and
an alignment unit having a position and/or location reference (ARF) of the calibrated constellation simulator configured for detecting a position and/or location of the calibrated constellation simulator in space, wherein the defined star formation (IRF) and the position and/or location reference (ARF) lie in a first fixed calibrated rotation (Q_{OSPS}) relative to one another.

2. The calibrated constellation simulator according to claim 1, wherein the optical device has at least one optical unit together with a light source and a static constellation mask with the defined star formation (IRF) of the star catalog or a static or dynamic display unit for representation of the defined star formation (IRF) of the star catalog.

3. The calibrated constellation simulator according to claim 1, wherein the fixed calibrated rotation (Q_{OSPS}) is implemented in a quaternion metric (Q_{OSPS}) or in a rotation matrix (A_{OSPS}).

4. The calibrated constellation simulator according claim 1, wherein the alignment unit has or is designed to have at least one unit from the following group of units: one or more mirror cubes, one or more prisms, one or more polished surfaces, and/or one or more reflective elements.

5. A system for calibrating and/or testing a star sensor assembled on a spacecraft, having:
the star sensor, which is assembled on the spacecraft and has sensor optics, wherein the sensor optics has an alignment reference (BRF) and the star sensor has a mechanical position and/or location reference (MRF) with respect to the spacecraft, and wherein the alignment reference (BRF) and the mechanical position and/or location reference (MRF) lie in a second rotation (Q_{STR}) with respect to one another;
the calibrated constellation simulator according to claim 1, arranged in space around the spacecraft; and
a detection unit assembled on the spacecraft, configured to detect at least one feature of the alignment unit of the calibrated constellation simulator,
wherein the system is configured to calibrate the star sensor and the calibrating comprises determining at least one feature of the alignment unit by the detection unit after converting the alignment reference (BRF) to the position and/or location reference (ARF) using the second rotation (Q_{STR}) and the fixed calibrated rotation (Q_{OSPS}).

6. The system according to claim 5, wherein the system is configured in such a manner that detecting the least one feature by the detection unit comprises optical detection using an optical detection unit.

7. The system according to claim 6, wherein the system is configured in such a manner that the optical detection is performed using autocollimation.

8. The system according to claim 5, wherein the fixed calibrated rotation (Q_{OSPS}) are or are implemented in a quaternion metric (Q_{OSPS}) or in a rotation matrix (A_{OSPS}).

9. The system according to claim 5, wherein the system is configured in such a manner that a transfer is determined by the following formula:
$${Q}_{A R F} ( BRF , IRF ) = Inv ( {Q}_{S T R} \times {Q}_{OSPS} )$$
wherein “Q_{ARF}” represents the transfer, “Inv” the operator for the inversion of a quaternion, “Q_{STR}” the quaternion output by the star sensor, ‘×’ the operator for the quaternion multiplication, and “Q_{OSPS}” the calibrated rotation.

10. The system according to claim 5, wherein the system is configured in such a manner that the calibration of the star sensor is performed to a reference system (SCRF) of the spacecraft.

11. The system according to claim 5, wherein the spacecraft is designed as a satellite, or a space capsule.

12. A method of calibrating and/or testing a star sensor assembled on a spacecraft using a calibrated constellation simulator, comprising the following method steps:
detecting a second rotation (Q_{STR}) resulting from a relative alignment reference (BRF) and a mechanical position and/or location reference (MRF), wherein the alignment reference (BRF) is a reference of sensor optics of the star sensor and the mechanical position and/or location reference (MRF) is a reference of the star sensor with respect to the spacecraft;
converting the alignment reference (BRF) to a position and/or location reference (ARF) of a calibrated constellation simulator using the second rotation (Q_{STR}) and a first fixed calibrated rotation (Q_{OSPS}), and
calibrating the star sensor by detecting at least one feature of an alignment unit of the calibrated constellation simulator by a detection unit assembled on the spacecraft.

13. The method according to claim 12, further comprising:
reading out of the fixed calibrated rotation (Q_{OSPS}), which results from a defined star formation (IRF) of a star catalog and the position and/or location reference (ARF) of an alignment unit of the calibrated constellation simulator.

14. A computing unit having a processor unit, a communication interface and a storage unit for calibrating and/or testing the star sensor assembled on the spacecraft for use in the calibrated constellation simulator according to claim 1.

15. A computer program, wherein the computer program is loadable into the storage unit of the computing unit according to claim 14 and has program code portions for causing the computing unit to execute the method for calibrating and/or testing the star sensor assembled on the spacecraft when the computer program is executed in the computing unit.
